(19) United States
(12) Patent Application Publication
(10) Pub. No.: US 2021/0139702 A1
(43) Pub. Date: May 13, 2021

(54) LIQUID SILICONE RUBBER (LSR) AND PREPARATION METHOD THEREOF

(71) Applicants: TSINGHUA UNIVERSITY, Beijing (CN); CRRC ZHUZHOU INSTITUTE CO., LTD., Zhuzhou (CN)

(72) Inventors: Zhimin DANG, Beijing (CN); Dongli ZHANG, Beijing (CN); Wenqing MEI, Beijing (CN); Sijiao WANG, Beijing (CN); Qikun FENG, Beijing (CN); Qunxin LIU, Beijing (CN)

(21) Appl. No.: 16/910,318

(22) Filed: Jun. 24, 2020

(30) Foreign Application Priority Data
Nov. 8, 2019 (CN) 201911088749.5

(51) Int. Cl. C08L 83/04; C08G 77/08; C08G 77/12; C08G 77/20; C08K 3/38; C08K 9/06; C08K 3/04; C08K 3/36; C08K 7/06; B01J 31/28

(52) U.S. Cl. CPC C08L 83/04; C08G 77/08; C08G 77/12; C08G 77/20; C08K 3/38; C08K 9/06; C08K 2201/003; C08K 3/36; C08K 7/06; B01J 31/28; C08L 2205/02; C08L 2203/202; C08K 2003/385; C08K 3/04

(57) ABSTRACT

The present invention discloses a liquid silicone rubber (LSR) and a preparation method thereof. The present invention comprises composition A and composition B at a weight ratio of (1:1) to (1:10), where composition A includes vinyl silicone oil, platinum catalyst, hexagonal boron nitride particles, and mechanical reinforcing agent, and composition B includes vinyl silicone oil, hydrogen-containing silicone oil, alkyne inhibitor, and hexagonal boron nitride particles. The LSR prepared by this method has excellent electrical insulation and thermal conductivity, exhibits a significant improvement in both thermal conductivity and electrical insulation, and has a breakdown strength of 42 kV/mm, and a thermal conductivity of 0.96 W·m⁻¹·K⁻¹ that increases by 557% compared to that of a pure LSR.

### CROSS-REFERENCE TO RELATED APPLICATIONS

This claims priority to Chinese Application No. 201911088749.5, filed Nov. 8, 2019, under 35 U.S.C. § 119(a). The above-referenced patent application is incorporated by reference in its entirety.

### BACKGROUND OF THE INVENTION

### Field of the Invention

The present invention relates to a packaging technology for power electronic devices, and in particular, relates to a liquid silicone rubber (LSR) and a preparation method thereof.

### Description of the Related Technology

In the fields of high-voltage external insulation and electronic devices, LSR is widely used due to its predominant insulation and mechanical properties. In recent years, as the operating voltage level and the operating speed for devices are increasingly improved, the silicone rubber material used for insulation subjects to excessive temperature during normal use, which accelerates the aging of the insulation material, thereby imposing great security risks on high-voltage transmission and power electronic devices. Therefore, it has become an urgent problem to improve the thermal conductivity and the insulation of silicone rubber materials.

### SUMMARY

In order to solve the above technical problems, the present application provides a boron nitride/liquid silicone rubber and preparation thereof, which can overcome the defects of the prior art. The product of the present invention has the following advantages: a simple preparation method, a reasonable formula for raw materials, easy generalization, and strong practicability, which enable the significant improvement of the physical and mechanical properties and the electrical insulation of the LSR material.

The present invention provides an LSR and a preparation method thereof, and raw materials of the LSR include composition A and composition B.

The formula of composition A includes the following raw materials: 100 parts by weight of vinyl silicone oil, 0.3 to 0.8 part by weight of platinum catalyst, 0 to 40 parts by weight of hexagonal boron nitride particles, and 10 to 20 parts by weight of mechanical reinforcing agent.

The formula of composition B includes the following raw materials: 100 parts by weight of vinyl silicone oil, 10 to 30 parts by weight of hydrogen-containing silicone oil, 0.02 to 0.05 parts by weight of alkyne inhibitor, and 0 to 40 parts by weight of hexagonal boron nitride particles.

Optionally, the formula of composition A includes the following raw materials: 100 parts by weight of vinyl silicone oil, 0.3 to 0.8 part by weight of platinum catalyst, 1 to 40 parts by weight of hexagonal boron nitride particles, and 10 to 20 parts by weight of mechanical reinforcing agent.

Optionally, the formula of composition B includes the following raw materials: 100 parts by weight of vinyl silicone oil, 10 to 30 parts by weight of hydrogen-containing silicone oil, 0.02 to 0.05 part by weight of alkyne inhibitor, and 1 to 40 parts by weight of hexagonal boron nitride particles.

The compositions A and B are mixed at a weight ratio of (1:1) to (1:10).

Optionally, the LSR is composed only of composition A and composition B, where composition A is composed only of vinyl silicone oil, platinum catalyst, hexagonal boron nitride particles, and mechanical reinforcing agent, and composition B is composed only of vinyl silicone oil, hydrogen-containing silicone oil, alkyne inhibitor, and hexagonal boron nitride particles.

In the LSR provided by the present invention, the vinyl silicone oil is selected from one or more of silicone oil containing only terminal vinyl groups, silicone oil containing only side vinyl groups, and silicone oil containing both terminal vinyl groups and side vinyl groups.

In the LSR provided by the present invention, the hydrogen-containing silicone oil is selected from one or more of silicone oil containing only terminal hydrogens, silicone oil containing only side hydrogens, and silicone oil containing both terminal hydrogens and side hydrogens.

In the LSR provided by the present invention, the vinyl silicone oil has a viscosity of 500 cst to 1,000 cst, and contains 0.16 wt. % to 0.32 wt. % of vinyl.

In the LSR provided by the present invention, the hydrogen-containing silicone oil contains 0.58 wt. % to 1.60 wt. % of hydrogen.

In the LSR provided by the present invention, the mechanical reinforcing agent is one or two of fumed silica and carbon fiber.

In the LSR provided by the present invention, the hexagonal boron nitride has a diameter of 1 micron to 15 microns, and the surface of the hexagonal boron nitride is treated with a silane coupling agent KH-550 and/or KH570 by a ball milling process.

In the LSR provided by the present invention, the platinum catalyst is selected from one or more of alcohol-modified chelate of chloroplatinic acid, tetrahydrofuran-coordinated platinum chelate, and platinum-vinylsiloxane complex.

Optionally, the platinum catalyst is added in the form of a solution with a concentration of 1,000 ppm to 5,000 ppm.

In another aspect, the present invention provides a method for preparing the above LSR, including the following steps:

1) weighing and thoroughly mixing all raw materials of composition A, and weighing and thoroughly mixing all raw materials of composition B;

2) thoroughly mixing the mixture of composition A and the mixture of composition B; and

3) removing bubbles from the mixture obtained in step 2) under vacuum, and standing the resulting mixture to obtain the LSR.

In the above method according to the invention, the removing bubbles from the LSR is performed for 15 min to 30 min.

The beneficial effects of the present invention are as follows:

1) In the present invention, a boron nitride/LSR with high thermal conductivity and insulation is prepared by mechanical stirring and mixing. Both the thermal conductivity of the LSR and the electrical insulation of the matrix are intensified. It plays an extremely important role in heat dissipation of a high-frequency microelectronic device, increasing the working efficiency of a device, and extending the service life of a device.

2) The method for preparing the boron nitride/LSR disclosed in the present invention is simple, stable and reliable, avoiding problems including the low thermal conductivity when the LSR is used in fields such as high-voltage external insulation and power electronic devices, and the thermal aging of a material at high temperature. It is suitable for the large-scale industrialized production of LSR with high thermal conductivity and insulation.

Other features and advantages of the present invention will be described in the following specification, and some of these will become apparent from the description or be understood by implementing the present invention. Other advantages of the present invention can be implemented and obtained by solutions described in the specification.

### DETAILED DESCRIPTION OF CERTAIN INVENTIVE EMBODIMENTS

To make the objectives, technical solutions, and advantages of the present invention clearer, the examples of the present invention will be described in detail. It should be noted that the examples in the application and features in the examples may be arbitrarily combined with each other in a non-conflicting situation.

In the examples of the present invention, an LSR is provided, and raw materials of the LSR include composition A and composition B.

The formula of composition A includes the following raw materials: 100 parts by weight of vinyl silicone oil, 0.3 to 0.8 part by weight of platinum catalyst, 0 to 40 parts by weight of hexagonal boron nitride particles, and 10 to 20 parts by weight of mechanical reinforcing agent.

The formula of composition B includes the following raw materials: 100 parts by weight of vinyl silicone oil, 10 to 30 parts by weight of hydrogen-containing silicone oil, 0.02 to 0.05 parts by weight of alkyne inhibitor, and 0 to 40 parts by weight of hexagonal boron nitride particles.

Optionally, the formula of composition A includes the following raw materials: 100 parts by weight of vinyl silicone oil, 0.3 to 0.8 part by weight of platinum catalyst, 1 to 40 parts by weight of hexagonal boron nitride particles, and 10 to 20 parts by weight of mechanical reinforcing agent.

Optionally, the formula of composition B includes the following raw materials: 100 parts by weight of vinyl silicone oil, 10 to 30 parts by weight of hydrogen-containing silicone oil, 0.02 to 0.05 part by weight of alkyne inhibitor, and 1 to 40 parts by weight of hexagonal boron nitride particles.

Optionally, the LSR is composed only of composition A and composition B, where composition A is composed only of vinyl silicone oil, platinum catalyst, hexagonal boron nitride particles, and mechanical reinforcing agent, and composition B is composed only of vinyl silicone oil, hydrogen-containing silicone oil, alkyne inhibitor, and hexagonal boron nitride particles.

The compositions A and B are mixed at a weight ratio of (1:1) to (1:10).

In the LSR provided by the present invention, the vinyl silicone oil is selected from one or more of silicone oil containing only terminal vinyl groups, silicone oil containing only side vinyl groups, and silicone oil containing both terminal vinyl groups and side vinyl groups.

In the LSR provided by the present invention, the hydrogen-containing silicone oil is selected from one or more of silicone oil containing only terminal hydrogens, silicone oil containing only side hydrogens, and silicone oil containing both terminal hydrogens and side hydrogens.

In the LSR provided by the present invention, the vinyl silicone oil has a viscosity of 500 cst to 1,000 cst, and contains 0.16 wt. % to 0.32 wt. % of vinyl.

In the examples of the present invention, the hydrogen-containing silicone oil contains 0.58 wt. % to 1.60 wt. % of hydrogen.

In the examples of the present invention, the mechanical reinforcing agent is one or two of fumed silica and carbon fiber.

In the examples of the present invention, the hexagonal boron nitride has a diameter of 1 micron to 15 microns, and the surface of the hexagonal boron nitride is treated with a silane coupling agent KH-550 and/or KH570 by a ball milling process.

In the examples of the present invention, the platinum catalyst is selected from one or more of alcohol-modified chelate of chloroplatinic acid, tetrahydrofuran-coordinated platinum chelate, and platinum-vinylsiloxane complex.

Optionally, the platinum catalyst is added in the form of a solution with a concentration of 1,000 ppm to 5,000 ppm.

In the examples of the present invention, a method for preparing the above LSR includes the following steps:

1) weighing and thoroughly mixing all raw materials of composition A, and weighing and thoroughly mixing all raw materials of composition B;

2) thoroughly mixing the mixture of composition A and the mixture of composition B; and

3) removing bubbles from the mixture obtained in step 2) under vacuum, and standing the resulting mixture to obtain the LSR.

In the examples of the present invention, the removing bubbles from the LSR is performed for 15 min to 30 min.

In the examples of the present invention, the vinyl silicone oil is one or more of terminal-vinyl silicone oil and side-vinyl silicone oil, purchased from Jiande Polymer New Materials Co., Ltd. with a trade name of Guiyou-SIFCO.

In the examples of the present invention, the hydrogen-containing silicone oil is one or more of terminal-hydrogen silicone oil and side-hydrogen silicone oil, purchased from Jiande Polymer New Materials Co., Ltd. with a trade name of Guiyou-JH-202.

In the examples of the present invention, the platinum catalyst is alcohol-modified chelate of chloroplatinic acid, purchased from Dongguan Zhongxin Organic Silicon Materials Co., Ltd. with a trade name of Zhongxin-PT. Alkyne inhibitor was purchased from Dongguan Zhongxin Organic Silicon Materials Co., Ltd. with a trade name of Zhongxin-C-002.

Fumed silica was purchased from Jiangsu Haoneng Chemical Co., Ltd. with a trade name of HN-200.

Boron nitride was purchased from Dandong Light Chemical Research Institute Co., Ltd.

In the examples of the present invention, the boron nitride is hexagonal boron nitride having a diameter of 10 microns. The surface of the hexagonal boron nitride is treated as follows: BN is placed in an oven and dried at 135° C. for 4 h, and poured into a ball mill immediately after the drying; KH550 is added at a weight ratio of BN to KH550 of 100:1, and the mixture is ground for 12 h; then the resulting mixture stands until the mixture is cooled to room temperature; and the cooled mixture is sieved to collect the surface-treated hexagonal boron nitride.

In the examples of the present invention, the LSR is tested as follows:

Breakdown strength is measured according to GB/T 1408.1-2006, with a sample thickness of 1 mm±0.1 mm. The data are processed by weibull distribution.

Volume resistivity is measured according to GB/T 1408.1-2006, with a sample thickness of 2 mm±0.1 mm and a test voltage of 100 V.

### EXAMPLE 1

The LSR in Example 1 is prepared according to the following steps.

1) Preparation of composition A: 100 parts by weight of vinyl silicone oil (viscosity: 500 cst) containing 0.16 wt. % of vinyl, 0.5 part by weight of platinum catalyst (the platinum catalyst is added in the form of a solution with a mass concentration of 1,000 ppm), 40 parts by weight of BN, and 20 parts by weight of fumed silica were weighed and thoroughly mixed by 1 h of stirring at room temperature for further use.

2) Preparation of composition B: 100 parts by weight of vinyl silicone oil (viscosity 500 cst) containing 0.16 wt. % of vinyl, 30 parts by weight of hydrogen-containing silicone oil (Guiyou-JH-202, hydrogen content: 1.60 wt. %), 0.02 part by weight of alkyne inhibitor, and 40 parts by weight of BN were weighed and thoroughly mixed by 1 h of stirring at room temperature for further use.

3) Composition A and composition B were mixed at a ratio of 1:1, stirred for 0.5 h, and then introduced into a mold. Then the mold was placed in a vacuum oven for 30 min to remove bubbles. After a period of standing, an LSR with high thermal conductivity and insulation was obtained for Example 1.

The main properties of the silicone rubber prepared in Example 1 are listed in Table 1.

TABLE 1
Properties of the silicone rubber prepared in Example 1

| Number | Property | Unit | Parameter |
|---|---|---|---|
| 1 | elastic modulus | MPa | 1.1 |
| 2 | strain | % | 330 |
| 3 | breakdown strength | MV/m | 42 |
| 4 | volume resistivity | Ω · cm−¹ | 8.2 × 10¹⁶ |
| 5 | thermal conductivity | W/mK | 0.96 |

### EXAMPLE 2

The LSR in Example 2 is prepared according to the following steps.

1) Preparation of composition A: 100 parts by weight of vinyl silicone oil (viscosity: 500 cst) containing 0.16 wt. % of vinyl, 0.5 part by weight of platinum catalyst (the platinum catalyst is added in the form of a solution with a mass concentration of 1,000 ppm), 20 parts by weight of BN, and 10 parts by weight of fumed silica were weighed and thoroughly mixed by 1 h of stirring at room temperature for further use.

2) Preparation of composition B: 100 parts by weight of vinyl silicone oil (viscosity 500 cst) containing 0.16 wt. % of vinyl, 30 parts by weight of hydrogen-containing silicone oil (hydrogen content: 1.60 wt. %), 0.02 part by weight of alkyne inhibitor, and 20 parts by weight of BN were weighed and thoroughly mixed by 1 h of stirring at room temperature for further use.

3) Composition A and composition B were mixed at a ratio of 1:1, stirred for 0.5 h, and then introduced into a mold. Then the mold was placed in a vacuum oven for 30 min to remove bubbles. After a period of standing, an LSR was obtained for Example 2.

The main properties of the silicone rubber prepared in Example 2 are listed in Table 2.

TABLE 2
Properties of the silicone rubber prepared in Example 2

| Number | Property | Unit | Parameter |
|---|---|---|---|
| 1 | elastic modulus | MPa | 0.8 |
| 2 | strain | % | 225 |
| 3 | breakdown strength | MV/m | 30 |
| 4 | volume resistivity | Ω · cm⁻¹ | 1.1 × 10¹⁶ |
| 5 | thermal conductivity | W/mK | 0.61 |

### EXAMPLE 3

The LSR in Example 3 is prepared according to the following steps.

1) Preparation of composition A: 100 parts by weight of vinyl silicone oil (viscosity: 1000 cst) containing 0.32 wt. % of vinyl, 0.3 part by weight of platinum catalyst (the platinum catalyst is added in the form of a solution with a mass concentration of 1,000 ppm), 40 parts by weight of BN, and 20 parts by weight of fumed silica were weighed and thoroughly mixed by 1 h of stirring at room temperature for further use.

2) Preparation of composition B: 100 parts by weight of vinyl silicone oil (viscosity 1,000 cst) containing 0.32 wt. % of vinyl, 30 parts by weight of hydrogen-containing silicone oil (hydrogen content: 1.60 wt. %), 0.02 part by weight of alkyne inhibitor, and 40 parts by weight of BN were weighed and thoroughly mixed by 1 h of stirring at room temperature for further use.

3) Composition A and composition B were mixed at a ratio of 1:1, stirred for 0.5 h, and then introduced into a mold. Then the mold was placed in a vacuum oven for 30 min to remove bubbles. After a period of standing, an LSR was obtained for Example 3.

The main properties of the silicone rubber prepared in Example 3 are listed in Table 3.

TABLE 3
Properties of the silicone rubber prepared in Example 3

| Number | Property | Unit | Parameter |
|---|---|---|---|
| 1 | elastic modulus | MPa | 0.4 |
| 2 | strain | % | 170 |
| 3 | breakdown strength | MV/m | 30 |
| 4 | volume resistivity | Ω · cm⁻¹ | 2.3 × 10¹⁶ |
| 5 | thermal | W/mK | 0.73 |
| | conductivity | | |

### EXAMPLE 4

The LSR in Example 4 is prepared according to the following steps.

1) Preparation of composition A: 100 parts by weight of vinyl silicone oil (viscosity: 1,000 cst) containing 0.32 wt. % of vinyl, 0.3 part by weight of platinum catalyst (the platinum catalyst is added in the form of a solution with a mass concentration of 1,000 ppm), 20 parts by weight of BN, and 20 parts by weight of fumed silica were weighed and thoroughly mixed by 1 h of stirring at room temperature for further use.

2) Preparation of composition B: 100 parts by weight of vinyl silicone oil (viscosity 500 cst) containing 0.16 wt. % of vinyl, 30 parts by weight of hydrogen-containing silicone oil (hydrogen content: 1.60 wt. %), 0.02 part by weight of alkyne inhibitor, and 40 parts by weight of BN were weighed and thoroughly mixed by 1 h of stirring at room temperature for further use.

3) Composition A and composition B were mixed at a ratio of 1:1, stirred for 0.5 h, and then introduced into a mold. Then the mold was placed in a vacuum oven for 30 min to remove bubbles. After a period of standing, an LSR was obtained for Example 4.

The main properties of the silicone rubber prepared in Example 4 are listed in Table 4.

TABLE 4
Properties of the silicone rubber prepared in Example 4

| Number | Property | Unit | Parameter |
|---|---|---|---|
| 1 | elastic modulus | MPa | 0.6 |
| 2 | strain | % | 264 |
| 3 | breakdown strength | MV/m | 38 |
| 4 | volume | Ω · cm⁻¹ | 4.7 × 10¹⁶ |
| | resistivity | | |
| 5 | thermal conductivity | W/mK | 0.66 |

The LSR prepared by this invention has excellent electrical insulation and thermal conductivity. The boron nitride/LSR prepared by the invention exhibits a significant improvement in both thermal conductivity and electrical insulation. The LSR provided by the invention has a breakdown strength of 42 kV/mm, and a thermal conductivity of 0.96 W·m⁻¹·K⁻¹ that increases by 557% compared to that of a pure LSR.

The foregoing description only provides preferred specific implementations of the present invention, and the protection scope of the present invention is not limited thereto. Any equivalent replacement or modification made according to the technical solution and inventive concept by a person skilled in the art within a technical scope of the present invention shall fall within the protection scope of the present invention.

What is claimed is:

1. A liquid silicone rubber (LSR), wherein raw materials of the LSR comprise composition A and composition B;
the formula of composition A comprises the following raw materials: 100 parts by weight of vinyl silicone oil, 0.3 to 0.8 part by weight of platinum catalyst, 0 to 40 parts by weight of hexagonal boron nitride particles, and 10 to 20 parts by weight of mechanical reinforcing agent;
the formula of composition B comprises the following raw materials: 100 parts by weight of vinyl silicone oil, 10 to 30 parts by weight of hydrogen-containing silicone oil, 0.02 to 0.05 parts by weight of alkyne inhibitor, and 0 to 40 parts by weight of hexagonal boron nitride particles;
optionally, the formula of composition A comprises the following raw materials: 100 parts by weight of vinyl silicone oil, 0.3 to 0.8 part by weight of platinum catalyst, 1 to 40 parts by weight of hexagonal boron nitride particles, and 10 to 20 parts by weight of mechanical reinforcing agent;
optionally, the formula of composition B comprises the following raw materials: 100 parts by weight of vinyl silicone oil, 10 to 30 parts by weight of hydrogen-containing silicone oil, 0.02 to 0.05 part by weight of alkyne inhibitor, and 1 to 40 parts by weight of hexagonal boron nitride particles; and
compositions A and B are mixed at a weight ratio of (1:1) to (1:10).

2. The LSR according to claim 1, wherein
the vinyl silicone oil is selected from one or more of silicone oil containing only terminal vinyl groups, silicone oil containing only side vinyl groups, and silicone oil containing both terminal vinyl groups and side vinyl groups.

3. The LSR according to claim 1, wherein
the hydrogen-containing silicone oil is selected from one or more of silicone oil containing only terminal hydrogens, silicone oil containing only side hydrogens, and silicone oil containing both terminal hydrogens and side hydrogens.

4. The LSR according to claim 1, wherein the vinyl silicone oil has a viscosity of 500 cst to 1,000 cst, and comprises 0.16 wt. % to 0.32 wt. % of vinyl.

5. The LSR according to claim 2, wherein the vinyl silicone oil has a viscosity of 500 cst to 1,000 cst, and comprises 0.16 wt. % to 0.32 wt. % of vinyl.

6. The LSR according to claim 3, wherein the vinyl silicone oil has a viscosity of 500 cst to 1,000 cst, and comprises 0.16 wt. % to 0.32 wt. % of vinyl.

7. The LSR according to claim 1, wherein the hydrogen-containing silicone oil comprises 0.58 wt. % to 1.60 wt. % of hydrogen.

8. The LSR according to claim 2, wherein the hydrogen-containing silicone oil comprises 0.58 wt. % to 1.60 wt. % of hydrogen.

9. The LSR according to claim 3, wherein the hydrogen-containing silicone oil comprises 0.58 wt. % to 1.60 wt. % of hydrogen.

10. The LSR according to claim 1, wherein the mechanical reinforcing agent is one or two of fumed silica and carbon fiber.

11. The LSR according to claim 2, wherein the mechanical reinforcing agent is one or two of fumed silica and carbon fiber.

12. The LSR according to claim 3, wherein the mechanical reinforcing agent is one or two of fumed silica and carbon fiber.

13. The LSR according to claim 1, wherein the hexagonal boron nitride has a diameter of 1 micron to 15 microns, and the surface of the hexagonal boron nitride is treated with a silane coupling agent KH-550 and/or KH570 by a ball milling process.

14. The LSR according to claim 2, wherein the hexagonal boron nitride has a diameter of 1 micron to 15 microns, and the surface of the hexagonal boron nitride is treated with a silane coupling agent KH-550 and/or KH570 by a ball milling process.

15. The LSR according to claim 3, wherein the hexagonal boron nitride has a diameter of 1 micron to 15 microns, and the surface of the hexagonal boron nitride is treated with a silane coupling agent KH-550 and/or KH570 by a ball milling process.

16. A method for preparing the LSR according to claim 1, wherein the platinum catalyst is selected from one or more of alcohol-modified chelate of chloroplatinic acid, tetrahydrofuran-coordinated platinum chelate, and platinum-vinylsiloxane complex; and
optionally, the platinum catalyst is added in the form of a solution with a concentration of 1,000 ppm to 5,000 ppm.

17. A method for preparing the LSR according to claim 2, wherein the platinum catalyst is selected from one or more of alcohol-modified chelate of chloroplatinic acid, tetrahydrofuran-coordinated platinum chelate, and platinum-vinylsiloxane complex; and
optionally, the platinum catalyst is added in the form of a solution with a concentration of 1,000 ppm to 5,000 ppm.

18. A method for preparing the LSR according to claim 3, wherein the platinum catalyst is selected from one or more of alcohol-modified chelate of chloroplatinic acid, tetrahydrofuran-coordinated platinum chelate, and platinum-vinylsiloxane complex; and
optionally, the platinum catalyst is added in the form of a solution with a concentration of 1,000 ppm to 5,000 ppm.

19. A method for preparing the LSR according to claim 2, comprising the following steps of:
1) weighing and thoroughly mixing all raw materials of composition A, and weighing and thoroughly mixing all raw materials of composition B;
2) thoroughly mixing the mixture of composition A and the mixture of composition B; and
3) removing bubbles from the mixture obtained in step 2) under vacuum, and standing the resulting mixture to obtain the LSR.

20. The method for preparing an LSR according to claim 19, wherein the removing bubbles from the LSR is performed for 15 min to 30 min.
